(19) United States
(12) Patent Application Publication
(10) Pub. No.: US 2014/0144765 A1
(43) Pub. Date: May 29, 2014

(54) PCB TACT SWITCH

(71) Applicant: Soo Ho Lee, Seo-gu (KR)

(72) Inventor: Soo Ho Lee, Seo-gu (KR)

(73) Assignee: Chang Ho Lee, Incheon (KR)

(21) Appl. No.: 13/812,463

(22) PCT Filed: Jul. 11, 2011
(86) PCT No.: PCT/KR2011/005052

§ 371 Date: Jun. 3, 2013

(30) Foreign Application Priority Data
Jul. 28, 2010 (KR) 1020100072738

(51) Int. Cl. H01H 13/12

(52) U.S. Cl. CPC H01H 13/12
USPC 200/512

(57) ABSTRACT

The invention relates to a PCB tact switch, and more particularly, to a PCB tact switch having excellent water resistance because same does not have holes on the top and bottom which are open to the outside, capable of preventing erroneous operation through improved contact point safety, and capable of preventing product disengagement through improved fixing strength by being soldered to a substrate. The PCB tact switch of the present invention comprises: an insulation member (100) forming an insulator in a thin plate-shape through which electricity does not pass; an upper conductive substrate (300) formed of a conductor through which electricity may pass, covering the upper surface of the insulation member (100), and including a central contact point terminal (340) and an external contact point terminal (330) by means of a disconnecting portion (310); a lower conductive substrate (400) at the lower surface of the insulation member (100), having an insulation adhesive film (200) deposited on the upper portion thereof, and electrically connected with the upper substrate (300) by means of a through-hole (410); a metal dome (500) which is resiliently deformed by the click from a user, and which electrically connects or disconnects the upper conductive substrate (300) and the lower conductive substrate (400); an insulation film as an insulation cover (600) entirely covering the top portions of the upper conductive substrate (300) and the metal dome (500) and protecting the insides thereof; and an insulation solder mask (700) bonded to the undersurface of the lower conductive substrate (400) and covering the portions with an insulator, except for those requiring soldering, wherein a receiving slot (360) is formed by a receiving slot (110) defined through the insulation member (100) and the insulation film (111), and the metal dome (500) is disposed within the receiving slot (360).

### TECHNICAL FIELD

The invention relates to a PCB tact switch and in particular to a PCB tact switch which has no holes that are open to the outside on the top and the bottom to ensure good water resistance and which is capable of preventing erroneous operation by an improved contact-point stability and also capable of preventing disengagement by being soldered to a substrate to improve the fixing strength.

### BACKGROUND ART

In general, a tact switch opens and closes an electrical circuit by a soft touch and is widely being used in the field of electronic devices since it advantageously ensures an accurate open/shut of the circuit and provides a simple structure.

Recently, the tact switch is being used for small devices such as a cellular phone, mobile devices, a laptop, a portable cassette player, a MP3 player, etc. and thus a light, small and thin PCB-type tact switch is being released.

A general PCB tact switch is shown in FIG. 6.

The PCB tact switch comprises:

an insulation member 10 in the shape of a thin plate and made of a nonconductor through which electricity does not pass,

an upper conductive substrate 20 which is located on the insulation member 10 and which has a conducting disconnection portion to electrically disconnect a central contact-point portion 21 and an outer contact-point portion 23,

a lower conductive substrate 30 which is located on the bottom of the insulation member 10 and made of conductive material,

a metal dome 40 which is made of a resilient and conductive metal and rests on outer contact-point portions 23 of the upper conductive substrate, wherein the center protrudes in a dome-shape and is spaced apart from the central contact-point portion 21 and it is pressed to be in contact with the central contact-point portion 21 for the electrical connection,

an insulation cover film 50 which is a nonconductor and fixes the metal dome 40 to the upper surface of the upper conductive substrate 20, and

a through-hole 60 which electrically connects the central contact-point portion 21 with the lower conductive substrate 30 upon clicking the metal dome 40,

a solder mask 70 which covers the lower conductive substrate except portions requiring soldering with a nonconductor.

Therefore, if the center of the metal dome 40 is pressed by a user when the switch is applied to an electronic device, a circuit connected to an edge of the lower conductive substrate 30 by soldering is operated or an operation signal is applied when the center of the metal dome is made to be in contact with the central contact-point portion 21 since the periphery of the metal dome 40 is already in contact with the outer contact-point portions 23.

Further, the process for manufacturing a PCB tact switch comprises the following steps: drilling the body of the substrate; copper plating of the outer surface of the upper and lower conductive substrates 20, 30 including the circumference of the hole such that they are made to be electrically conductive; etching to cut the copper plated portions to be electrically disconnected for the switching function when electrically connected; and printing solder mask portions for electrical insulation.

But, the above PCB tact switch has problems such as high manufacturing cost and probability of defective product since the manufacturing process and the structure are complicated.

A plurality of complicated manufacturing processes for the finishing the product causes the manufacturing time to be increased and the work efficiency to be decreased, thereby increasing the manufacturing cost.

When the metal dome is pressed by click, the center of the metal dome becomes in contact with the upper conductive substrate. At this time, air in the metal dome cannot be discharged and therefore, the touch feeling is not good. This is one of the problems that the prior tact switch has.

Also, the contact-point of the upper conductive substrate is flat, the contact is defective due to the foreign substance.

Further, since the upper conductive substrate is flat, an adhesive may be inserted between the metal dome and the upper conductive substrate during the bonding of a cover lay, which causes a defective contact.

Foreign substance causes a defective contact and electrical error and in particular, water causes a short circuit to destroy the electronic device.

### DISCLOSURE OF THE INVENTION

### Technical Problem

The object of the invention is to provide a PCB tact switch which increases a stability of the assembly, a touch feeling and a quality by providing an upper conductive substrate with a receiving slot on which a metal dome rests.

Another object of the invention is to provide a PCB tact switch which increases a stability of the contact-point by the line-contact of the central contact-point step when the metal dome is in contact with the upper conductive substrate.

Yet another object of the invention is to provide a PCB tact switch which has an excellent water-resistance by preventing a hole or a gap which is open to the outside.

### Technical Solution

To achieve the object of the invention, the invention provides a PCB tact switch comprising: an insulation member 100 forming an insulator in a thin plate-shape through which electricity does not pass; an upper conductive substrate 300 which is formed of a conductor through which electricity passes, which covers the upper surface of the insulation member 100, and which includes a central contact-point terminal 320 and an external contact-point terminal 330 by means of a disconnecting portion 310; a lower conductive substrate 400 which is disposed at the bottom of the insulation member 100, wherein an insulation adhesive film 200 is deposited on the upper portion of the lower conductive substrate and the lower conductive substrate is electrically connected with the upper conductive substrate 300 by means of a through-hole 410; a metal dome 500 which is resiliently deformed by the click from a user and which electrically connects or disconnects the upper conductive substrate 300 and the lower conductive substrate 400; an insulation cover film 600 which entirely covers the top portions of the upper conductive substrate 300 and the metal dome 500 to protect the inside; and an insulation solder mask 700 bonded to the bottom surface of the lower conductive substrate 400 to cover with an insulator the lower conductive substrate except for portions which requires soldering, wherein a receiving slot 360 is formed by a receiving slot 110 which passes though the insulation member 100 and an insulation film 111 and wherein the metal dome 500 is disposed within the receiving slot 360.

Here, a silicone adhesive is applied to the bottom of the insulation cover film 600 at the contact portion with the metal dome 500.

Further, a through-hole 611 is formed on the center of the insulation cover film 600 such that the center of the metal dome 500 is exposed to the outside and only the periphery of the metal dome 500 is bonded by an adhesive 620.

An adhesive film 800 having a through-hole 810 is disposed between the upper conductive substrate 300 and the insulation cover film 600.

Also, the insulation cover film 600 and the solder mask 700 may exchange their function by the change of the installation location of the metal dome 500.

### Advangateous Effect

According to the invention, the inner electrical contact-point portion is not exposed to the outside to obtain a sealed structure and an excellent water-resistance.

Also, the metal dome 500 is located on the receiving slot 360 in the insulation member 100 and air can be discharged into the step area when the metal dome 500 is pressed, thereby increasing the touch feeling.

The receiving hole 110 between the metal dome 500 and the upper conductive substrate 300 prevents a contact error.

Moreover, the line contact by the central contact-point step 350 of the upper conductive substrate 300 prevents a contact error due to foreign substance, thereby ensuring the quality of the product.

Further, the invention provides a thin and simple structure of the product, resulting in a low manufacturing cost.

### BRIEF DESCRIPTION OF THE DRAWINGS

FIG. 1 represents an exploded perspective view of a PCB tact switch according to the invention.

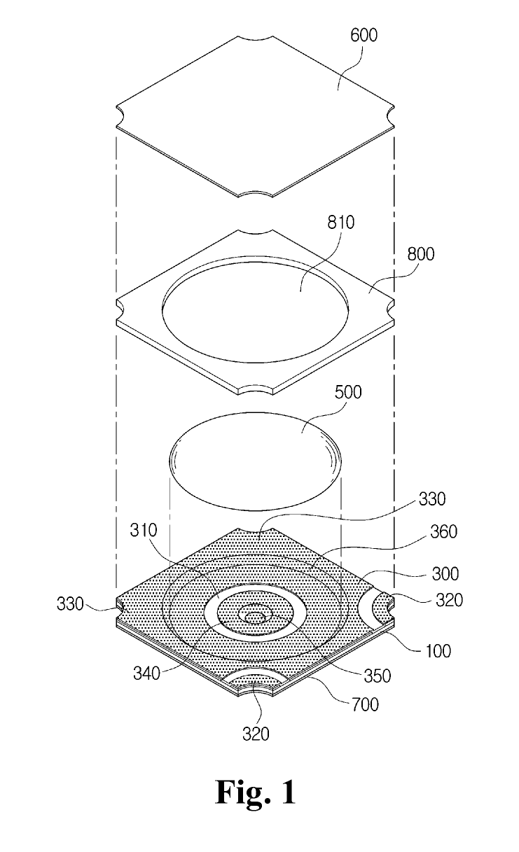

FIG. 2 represents a top view of an assembly of a PCB tact switch according to the invention.

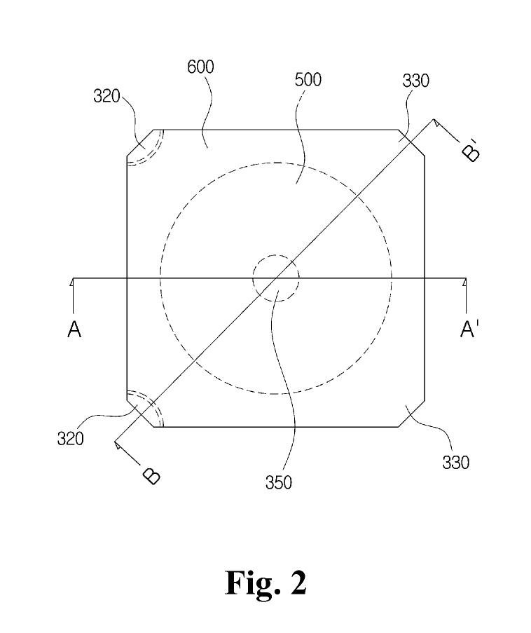

FIG. 3 represents a sectional view taken along the line A-A′ in FIG. 2.

FIG. 4 represents a sectional view taken along the line B-B′ in FIG. 2.

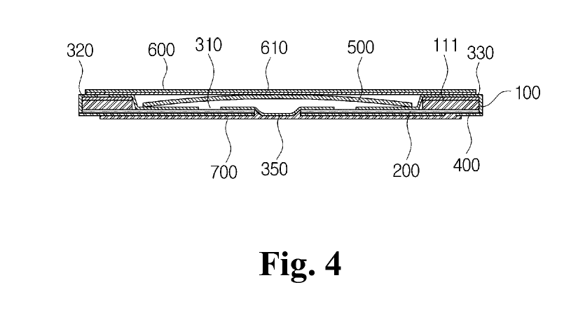

FIG. 5 represents an enlarged sectional view of respective parts before assembling the parts.

FIG. 6 represents a sectional view of FIG. 5 provided with a receiving slot and a through-hole.

FIG. 7 represents an enlarged sectional view showing that the upper conductive substrate is pressed and deformed to adhere to the edge of the receiving slot and the upper surface of the adhesive insulation film.

FIG. 8 represents an enlarged sectional view of bonding a metal dome to a contact portion of an insulation cover film by a silicone adhesive.

FIG. 9 represents an enlarged sectional view of an example showing that a through-hole is perforated on the insulation cover film and an adhesive is applied to the bottom of the insulation cover film such that the center of the metal dome is exposed and the infiltration of water is prevented.

FIG. 10 represents an enlarged sectional view of an example showing that the deformation direction of the upper conductive substrate and the lower conductive substrate is switched and the metal dome is arranged by pressing the lower conductive substrate into the receiving slot.

FIG. 11 represents a sectional view of a prior PCB tact switch.

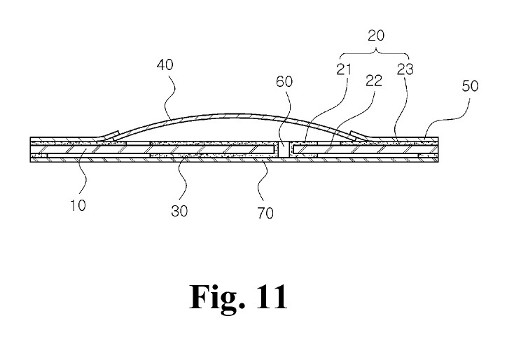

### BEST MODE FOR CARRYING OUT THE INVENTION

Hereinafter, preferred embodiments will be explained in detail referring to attached drawings.

As shown in the figures, an insulation member 100 of a PCB-type tact switch according to the invention is in the form of a thin plate which is an electrical insulator has an upper surface on which an insulation film 111 is attached.

After the insulation film 111 adheres to the upper surface of the insulation member, a receiving hole 110 is made in the center of the insulator and the hole has a little larger diameter than an outer diameter of a metal dome 500.

An upper conductive substrate 300 is located above the insulation member 100.

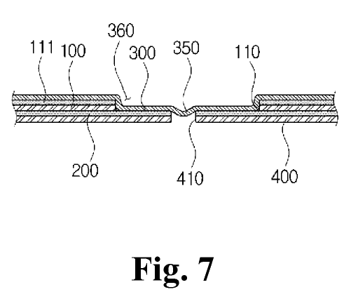

As shown in FIG. 7, during the manufacturing a thin plate conductor, when a pressure is applied to the upper surface of the upper conductive substrate 300, the upper conductive substrate is deformed to fit into the receiving hole 110 of the insulation member 100 and is pressed to adhere to an insulation adhesive film 200 such that a receiving slot 360 is created.

Then, by etching, the upper conductive substrate 300 is made to have a disconnecting portion 310 to electrically disconnect a circumferential portion from a central portion and a contact pad 320 which electrically connect the central portion of the upper conductive substrate to PCB substrate(not shown) by soldering is located on the insulation member 100.

A lower conductive substrate 400 is disposed under the insulation member 100 and a relatively-thin insulation adhesive film 200 is coated on the lower conductive substrate 400.

The lower conductive substrate 400 coated with the insulation adhesive film 200 is provided with a through-hole 410 having a diameter smaller than the receiving hole 110. When the upper conductive substrate 300 is pressed onto the through-hole 410, a concave portion is created such that a central contact-point step 350 is formed.

Therefore, the insulation member 100 and the insulation adhesive film 200 isolate the upper conductive substrate 300 from the lower conductive substrate 400 electrically in the upward and downward direction.

After the central through-hole 410 is formed, copper plating is carried out for the double-sided substrate. When a disconnecting portion is formed at a certain required location by etching, the through-hole 410 and the disconnecting portion are created which electrically connect the upper conductive substrate 300 and the lower conductive substrate 400.

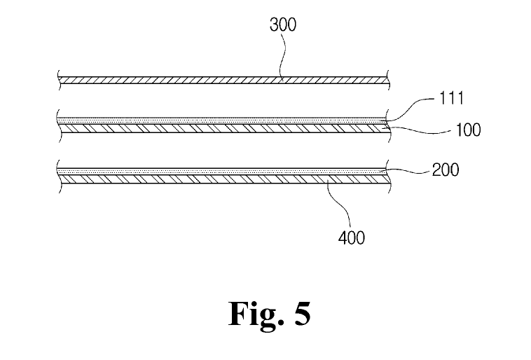

In FIGS. 5 to 7, a receiving hole 110 is drilled on the insulation member 100 and the upper conductive substrate is pressed to fit into the edge of the receiving hole 110. Further, the upper conductive substrate is pressed to fit onto the upper surface of the insulation adhesive film 200 so that the receiving slot 360 and the central contact-point step 350 are formed.

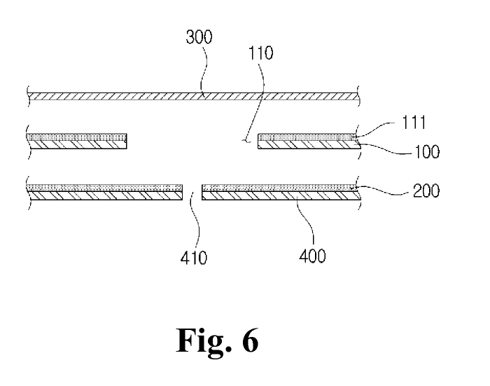

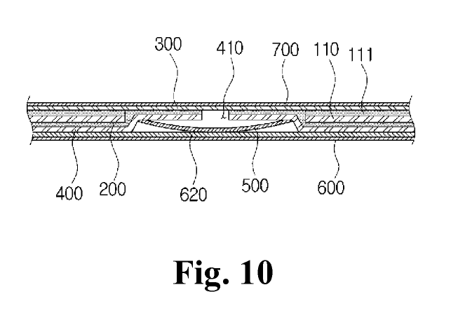

Alternatively, as shown in FIG. 10, while the upper conductive substrate 300 in FIG. 6 is made to remain in a plate shape, the outer surface of the lower conductive substrate 400 is pressed against the receiving hole 110 on the contrary to the above-described embodiment such that the insulation adhesive film 200 which is coated onto the lower conductive substrate 400 is pressed to adhere to the upper conductive substrate 300.

In this case, the metal dome 500 is installed in reverse and an insulation cover film 600 and an insulation solder mask 700 switch their function each other.

When the upper conductive substrate 300 or the lower conductive substrate 400 is installed in the receiving slot 360 formed by the receiving hole 110 of the insulation member 100 along the edge thereof, the metal dome 500 which is convex upwardly and has good elasticity is disposed in the receiving slot.

The edge of the metal dome 500 is connected with the lateral portion of the upper conductive substrate 300 which is electrically disconnected by the disconnection portion 310 at the upper part of the upper conductive substrate 300 such that the metal dome is electrically connected with the outer contact-point terminal 330.

An insulation cover film 600 onto whose bottom an adhesive is applied covers the upper conductive substrate 300 and the top of the metal dome 500 entirely to protect the inside from foreign substances, in particular water.

Here, an adhesive film 800 having a through-hole 810 may be provided between the upper conductive substrate 300 and the insulation cover film 600.

The adhesive film 800 creates a firm bond between the upper conductive substrate 300 and the insulation cover film 600 and keeps a flat height in accordance with the height of the metal dome 500.

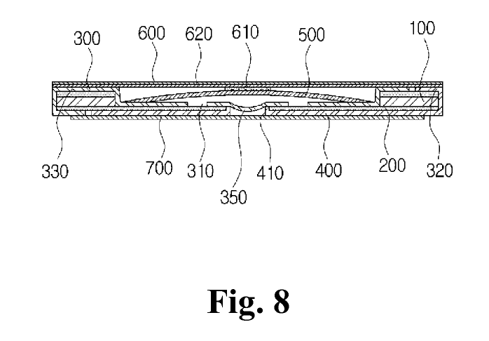

The insulation cover film 600 has an adhesive applied on the bottom and as shown in FIG. 8, a silicone adhesive 610 may be applied to the bottom surface of the insulation cover film 600 in view of the contact-point of the metal dome 500.

The silicone adhesive applied on the bottom of the insulation cover film 600 prevents the decrease of the touch feeling which would occur when the entire metal dome 500 is applied by an adhesive and fixes the metal dome 500 instantly by the viscosity of silicone, thereby facilitating the assembly and saving the manufacturing cost.

If a plurality of metal domes 500 are moved to the position where switches are arranged while the metal domes 500 are attached to the bottom of the insulation cover film and then the metal domes are placed on the receiving slot 360 formed by the receiving hole 110, it is possible to produce goods on a mass production basis without having to assemble the metal domes 500 one by one.

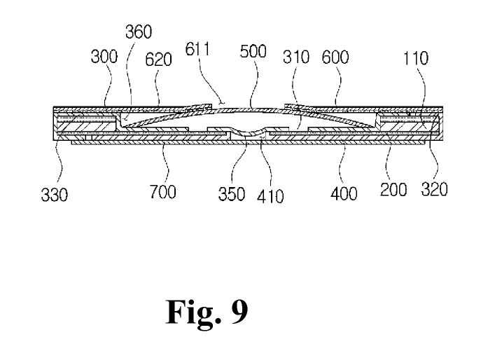

As shown in FIG. 9, a through-hole 611 is formed on the center of the insulation cover film 600 such that the insulation cover film is made to be open to the outside to expose the center portion of the metal dome 500, and the metal dome 500 may be attached by adhesive tape temporally, and then be fixed to the receiving slot 360 temporally, which facilitates a mass production.

A solder mask 700 is attached to the bottom of the lower conductive substrate 400 such that the mask, as an insulator, covers the lower conductive substrate except for portions which require soldering, thereby finishing the double-sided switch.

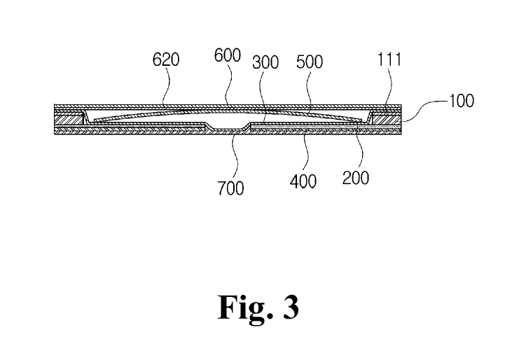

Here, if the center portion of the metal dome 500 covered by the insulation cover film 600 is pushed, the convex metal dome 500 is resiliently deformed as shown by an imaginary line in FIG. 3 so that the metal dome 500 is electrically connected with an outer contact-point terminal 330 by the disconnecting portion 310 of the upper conductive substrate 300.

The center of the metal dome 500 is electrically connected by the central contact-point portion 320.

The metal dome 500 has elasticity such that it returns to an initial condition when it is released from the pressure.

The process to manufacture a double-sided PCB tact switch according to the invention will be discussed below.

A thermosetting insulation adhesive film 200 is disposed on the upper surface of a copper plate forming the lower conductive substrate 400 and then a through-hole 410 is formed through the center of the copper plate and the insulation adhesive film 200.

The insulation film 100 having the receiving hole 110 is disposed on the upper surface of the adhesive insulation film 200 and the upper conductive substrate 300 is disposed on the upper surface of the insulation film 100. Then, they are heated and pressed against each other to become an assembly as shown in FIG. 7.

Here, a flat JIG is used at the bottom and PVC is used, and the upper conductive substrate 300 is pressed to be pushed down through the hole to the bottom to form a double-sided substrate by an high-pressure and high-temperature flow.

According to the above arrangement, no hole which is open to the inside is exposed to the outside on the top and the bottom of the switch, thereby ensuring excellent water-resistance.

Further, when the metal dome 500 is clicked, it is in line-contact with, not in point-contact with, the center of the upper conductive substrate 300 by means of the central contact-point step 350 defined by the periphery of the through-hole 410, which ensures a stable contact.

Moreover, the structure of the switch is made to be more simple and the thickness of the product is also made to be smaller since the metal dome 500 is located in the receiving slot 360 which is formed by the drilling of the insulation film 100, and the metal dome 500 is stably located therein, which ensures the easy assembly and good quality of the product.

1. A PCB tact switch comprising:
an insulation member 100 forming an insulator in a thin plate-shape through which electricity does not pass;
an upper conductive substrate 300 which is formed of a conductor through which electricity passes, which covers the upper surface of the insulation member 100, and which includes a central contact-point terminal 340 and an external contact-point terminal 330 that are disconnected by means of a disconnecting portion 310;
a lower conductive substrate 400 which is disposed at the bottom of the insulation member 100, wherein an adhesive insulation film 200 is deposited on the upper portion of the lower conductive substrate and the lower conductive substrate is electrically connected with the upper conductive substrate 300 by means of a through-hole 410;
a metal dome 500 which is resiliently deformed by the click from a user and which electrically connects or disconnects the upper conductive substrate 300 and the lower conductive substrate 400;
an insulation cover film 600 which entirely covers the top portions of the upper conductive substrate 300 and the metal dome 500 to protect the inside; and
an insulation solder mask 700 bonded to the bottom surface of the lower conductive substrate 400 to cover with an insulator the lower conductive substrate except for portions which requires soldering;
wherein a receiving slot 360 is formed by a receiving slot 110 which passes though the insulation member 100 and an insulation film 111 and wherein the metal dome 500 is disposed within the receiving slot 360.

2. The PCB tact switch according to claim 1, wherein a silicone elastomer is applied to the bottom of the insulation cover film 600 at the center of the metal dome 500.

3. The PCB tact switch according to claim 1, wherein a through-hole 611 is formed on the center of the insulation cover film 600 such that the center of the metal dome 500 is exposed to the outside and wherein only the periphery of the metal dome 500 is bonded by an adhesive 620.

4. The PCB tact switch according to claim 1, wherein an insulation film 111 is further added to the upper surface of the insulation member 100.

5. The PCB tact switch according to claim 1, wherein a central contact-point portion of the upper conductive substrate 300 is arranged to be in line-contact by a central contact-point step.

6. The PCB tact switch according to claim 1, wherein an adhesive film 800 having a through-hole 810 is disposed between the upper conductive substrate 300 and the insulation cover film 600.

7. The PCB tact switch according to claim 1, wherein the lower conductive substrate 400 is pressed such that a protruded portion of the adhesive insulation film 200 is pressed to be bonded to the edge of the receiving hole 110 and the bottom of the upper conductive substrate 300 and such that the metal dome 500 is located in the center of the lower conductive substrate 400.

8. The PCB tact switch according to claim 2, wherein an adhesive film 800 having a through-hole 810 is disposed between the upper conductive substrate 300 and the insulation cover film 600.

9. The PCB tact switch according to claim 3, wherein an adhesive film 800 having a through-hole 810 is disposed between the upper conductive substrate 300 and the insulation cover film 600.

10. The PCB tact switch according to claim 4, wherein an adhesive film 800 having a through-hole 810 is disposed between the upper conductive substrate 300 and the insulation cover film 600.

11. The PCB tact switch according to claim 5, wherein an adhesive film 800 having a through-hole 810 is disposed between the upper conductive substrate 300 and the insulation cover film 600.

12. The PCB tact switch according to claim 2, wherein the lower conductive substrate 400 is pressed such that a protruded portion of the adhesive insulation film 200 is pressed to be bonded to the edge of the receiving hole 110 and the bottom of the upper conductive substrate 300 and such that the metal dome 500 is located in the center of the lower conductive substrate 400.

13. The PCB tact switch according to claim 3, wherein the lower conductive substrate 400 is pressed such that a protruded portion of the adhesive insulation film 200 is pressed to be bonded to the edge of the receiving hole 110 and the bottom of the upper conductive substrate 300 and such that the metal dome 500 is located in the center of the lower conductive substrate 400.

14. The PCB tact switch according to claim 4, wherein the lower conductive substrate 400 is pressed such that a protruded portion of the adhesive insulation film 200 is pressed to be bonded to the edge of the receiving hole 110 and the bottom of the upper conductive substrate 300 and such that the metal dome 500 is located in the center of the lower conductive substrate 400.

15. The PCB tact switch according to claim 5, wherein the lower conductive substrate 400 is pressed such that a protruded portion of the adhesive insulation film 200 is pressed to be bonded to the edge of the receiving hole 110 and the bottom of the upper conductive substrate 300 and such that the metal dome 500 is located in the center of the lower conductive substrate 400.
